(19) United States
(12) Patent Application Publication
(10) Pub. No.: US 2006/0191384 A1
(43) Pub. Date: Aug. 31, 2006

(54) Telescopic ratchet extension

(76) Inventor: John Dougherty, West Islip, NY (US)

Correspondence Address: Law Offices of John D. Gugliotta, P.E., Esq., 202 Delaware Building, 137 South Main Street, Akron, OH, 44308, US

(21) Appl. No.: 10/126,009

(22) Filed: Aug. 13, 2002

(51) Int. Cl. B25B 23/16; B25G 1/04

(52) U.S. Cl. 81/177.2

(57) ABSTRACT

A telescopic ratchet extension is an apparatus to extend a ratchet drive to lengths being subject to no measurable limitation. An extension member is provided which includes an inner cylinder telescopically received by an outer cylinder. A locking apparatus serves to lock the inner cylinder at any position within the outer cylinder. The locking apparatus includes a locking tool which has a knurled gripping element removably affixed via crimping to the inner cylinder.

### RELATED APPLICATIONS

The present invention was first described in Disclosure Document Registration No. 488,646 filed on Feb. 14, 2001 under 35 U.S.C. §122 and 37 C.F.R. §1.14. There are no previously filed, nor currently any co-pending applications, anywhere in the world.

### BACKGROUND OF THE INVENTION

1. Field of the Invention

The present invention relates generally to hand tools and, more particularly, to a telescopic ratchet extension.

2. Description of the Related Art

As any mechanic who works on cars or mechanical equipment knows, there are tight places that require special tools to get at them. The proper tool can save time and money, and get the job done. If one is using a ratchet drive extension to reach a particularly elusive bolt, it can be frustrating, and you can end up exchanging different length extensions several times until you find the right length, that is, if you can find it. Typical existing adjustable extensions have detent holes spaced at intervals along a telescoping shaft, so that the shaft can only adjust to the length determined by the holes.

Accordingly, there exists a need for a continuously adjustable, telescoping ratchet extension that can be adjusted to any length. The development of the telescopic ratchet extension fulfills this need.

A search of the prior art did not disclose any patents that read directly on the claims of the instant invention; however, the following references were considered related. The following patents disclose a socket wrench extension: U.S. Pat. No. 6,170,365 issued in the name of Zerver; and U.S. Pat. No. 4,905,548 issued in the name of Colace et al.

The following patents describe a wrench with a handle having a telescoping sleeve: U.S. Pat. No. 5,109,737 issued in the name of Raber, and U.S. Pat. No. 2,978,938 issued in the name of Nalley.

The following patents disclose a tratchet tool with a rotatable hand hold and telescoping shaft: U.S. Pat. No. 4,070,932 issued in the name of Jeannotte; and U.S. Pat. No. 3,608,402 issued in the name of Rainey.

U.S. Pat. No. 6,186,033 issued in the name of Fard, Sr. describes an extensible, multi-positioning turning tool.

U.S. Pat. No. 6,038,946 issued in the name of Jackson et al. discloses an axially repositionable adapter for a ratchet assembly.

U.S. Pat. No. 5,836,223 issued in the name of Lin describes a tool with interchangeable pieces with an extending shaft.

Consequently, a need has been felt for a continuously adjustable, telescoping ratchet extension that can be adjusted to any length in an easy and effective manner.

### SUMMARY OF THE INVENTION

Therefore, it is an object of the present invention to provide a telescopic ratchet extension which is linearly adjustable.

It is another object of the present invention to provide a telescopic ratchet extension which can fit into small areas.

It is still another object of the present invention to provide a telescopic ratchet extension fabricated of tool steel being chrome plated, thus being rugged, durable, and non-corrosive.

It is still another object of the present invention a telescopic ratchet extension being of high strength and which collapses easily for storage.

It is another object of the present invention to provide a locking apparatus which allows for an outer cylinder to be locked at any position along an inner cylinder, thereby allowing for a complete range of linear adjustment.

It is another object of the present invention to provide measuring indicia which allows the user to adjust and lock the telescopic ratchet extension at a preselected position should the need arise.

Briefly described according to one embodiment of the present invention, a telescopic ratchet extension is an apparatus to extend a ratchet drive to lengths being subject to no measurable limitation. An extension member is provided which includes an inner cylinder telescopically received by an outer cylinder. In order to lock the inner cylinder at any position within the outer cylinder, a locking apparatus is provided which includes a locking tool. The locking tool has a knurled gripping element removably affixed via crimping to the inner cylinder.

The locking apparatus further includes a square-shaped slot extending therethrough for accommodating an insertion end of the inner cylinder. After insertion of the insertion end within the slot, clockwise rotation of the locking tool effectuates downward rotation by the locking tool, whereby a contacting surface thereof mechanically impinges against an outer circumferential sidewall of the inner cylinder, thereby positionably locking the inner cylinder against the locking tool within the outer cylinder. At this point, a socket is placed on the socket engaging end of the inner cylinder for engagement with a fastener to be tightened utilizing the telescopic ratchet extension.

In the event user desires to adjust a linear length of the extension member, user simply reinserts the insertion end of the inner cylinder within slot of the locking apparatus, and turns the locking tool in a counter-clockwise direction, thereby removing mechanical interference between the contacting surface thereof and the inner cylinder so as to allow the inner cylinder to freely telescope within the outer cylinder.

The locking apparatus allows for the inner cylinder to be locked at any position along the outer cylinder, thereby allowing for a complete range of linear adjustment.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a partially exploded perspective view of a telescopic ratchet extension according to the preferred embodiment of the present invention;

FIG. 2 is a partially exploded side elevational view of the telescopic ratchet extension according to the preferred embodiment of the present invention;

FIG. 3 is a partial cross-sectional view of the inner and outer cylinders according to the preferred embodiment of the present invention;

FIG. 4 is an end view of the outer cylinder according to the preferred embodiment of the present invention;

FIG. 5 is a side elevational view of the locking tool according to the preferred embodiment of the present invention;

FIG. 6 is a top plan view of the locking tool according to the preferred embodiment of the present invention; and

FIG. 7 is a perspective view of the telescopic ratchet extension shown with measuring indicia.

### DESCRIPTION OF THE PREFERRED EMBODIMENT

### 1. Detailed Description of the Figures

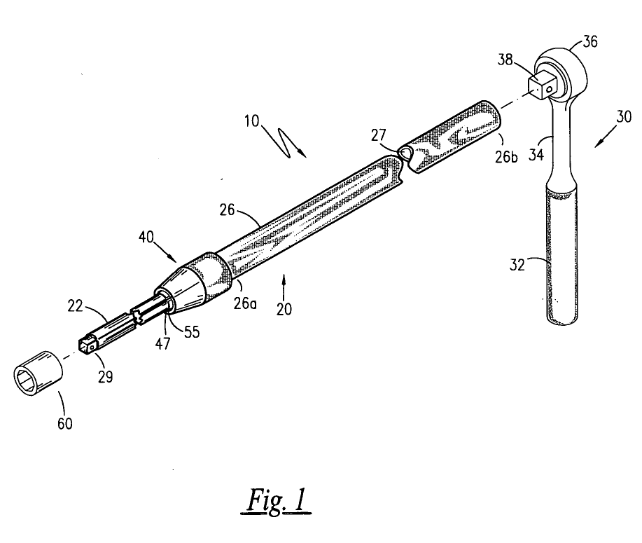

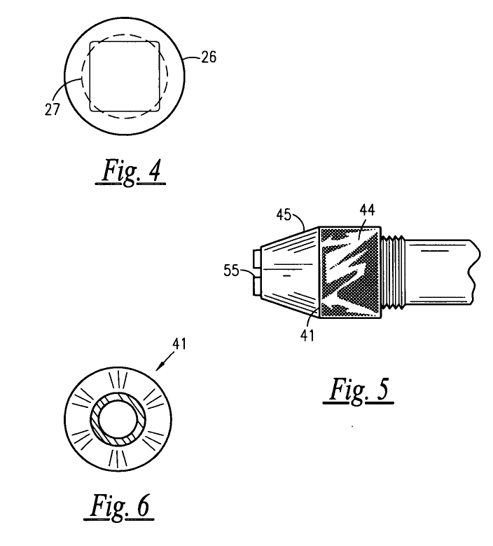

Referring now to FIGS. 1-4, a telescopic ratchet extension 10 is shown, according to the present invention, comprised of an elongated, cylindrical extension member 20 fabricated of a metal material, preferably tool steel being chrome plated, so as to retard rust. The extension member 20 includes an inner cylinder 22 telescopically received by an outer cylinder 26. The outer cylinder 26 is of a linearly, elongated configuration, having an anterior end 26a opposite a posterior end 26b, and a knurled, external circumferential surface. The outer cylinder 26 is further defined as having a circular cross-section and an inner cylinder receiving cavity 27 for intimate slidable engagement by the inner cylinder 22. The anterior end 26a of the outer cylinder 26 is defined as having a downwardly-tapering drive shaft 28 terminating into a socket engaging end 29. The anterior end 26a includes threads 26b for mating with corresponding threads 40a of a locking apparatus 40 (to be described in greater detail below).

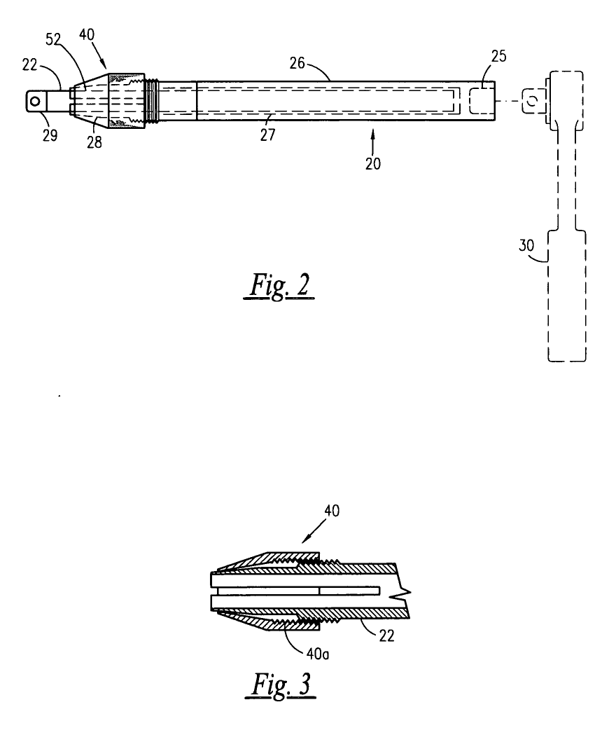

The inner cylinder 22 is of a linearly elongated configuration having a circular cross-section and a diameter measuring just shy a diameter of the inner cylinder receiving cavity 27 of the outer cylinder 26. The posterior end 26b of the outer cylinder 26 defines a ratchet receiving cavity 25 formed as a rectangular void for adaptive engagement by an extension engagement end 38 of a standard ratchet wrench 30. For purposes of this disclosure, a standard ratchet wrench 30, as shown in FIGS. 1 and 2, is defined as having a shank 34 with an elongated, knurled, cylindrical handle portion 32 at one end and a headpiece 36 at an opposite end, wherein the headpiece 36 includes an extension engagement end 38 for engagement within the ratchet receiving cavity 25 of the inner cylinder 22.

It is envisioned that a plurality of outer cylinders 26 are provided having multiple-sized ratchet receiving cavities 25 being available in ¼, ⅜, and ½ inch sizes for engagement with a correspondingly-sized extension engagement end 38 of a ratchet wrench 30.

In order to lock the inner cylinder 22 at any position within the outer cylinder 26, as best seen in FIGS. 2, 3, 5, and 6, a locking apparatus 40 is provided. The locking apparatus 40 comprises inner corresponding threads 40a for threadedly engaging threads 26b of the anterior end 26a of the outer cylinder 26. The locking apparatus further comprises a locking tool 41 which imparts important functional utility to the present invention as will be described hereinbelow. The locking tool 41 includes a knurled gripping element 44. The knurled gripping element 44 has a slightly downwardly-tapered lower portion 45 removably affixed via crimping to the inner cylinder 22.

The locking apparatus 40 includes a square-shaped slot 52 extending therethrough for accommodating an insertion end 47 of the inner cylinder 22. After insertion of the insertion end 47 within the slot 52, manual clockwise rotation of the locking tool 41 effectuates downward rotation by the locking tool 41, whereby a contacting surface 55 thereof mechanically impinges against an outer circumferential sidewall of the inner cylinder 22, thereby positionably locking the inner cylinder 22 against the locking tool 41 within the outer cylinder 26. At this point, a socket 60 is placed on the socket engaging end 29 of the inner cylinder 22 for engagement with a fastener to be tightened utilizing the telescopic ratchet extension 10.

In the event user desires to adjust a linear length of the extension member 20, user simply reinserts the insertion end 47 of the inner cylinder 22 within slot 52 of the locking apparatus 40, and manually turns the locking tool 41 in a counter-clockwise direction, thereby removing mechanical interference between the contacting surface 55 thereof and the inner cylinder 22 so as to allow the inner cylinder 22 to freely telescope within the outer cylinder 26.

The locking apparatus 40 allows for the inner cylinder 22 to be locked at any position along the outer cylinder 26, thereby allowing for a complete range of linear adjustment.

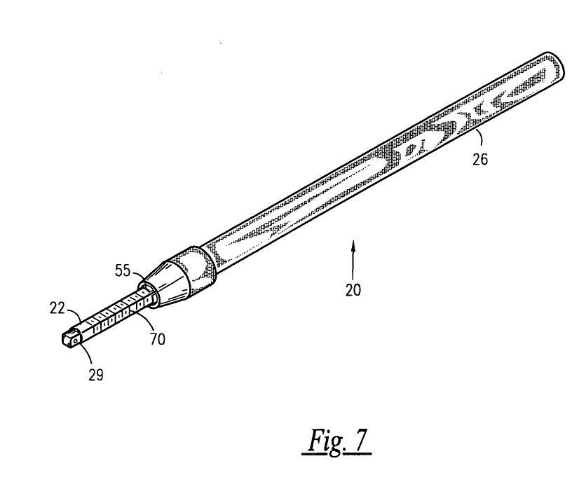

Referring now to FIG. 7, it is envisioned that measuring indicia 70 are engraved along the external circumferential surface of the inner cylinder 22 in a sequentially progressive manner. The measuring indicia 70 allow the user to adjust and lock the extension member 20 at a preselected position should the need arise.

### 2. Operation of the Preferred Embodiment

To use the present invention, a user slidably adjusts the inner cylinder 22 within the outer cylinder 26 to a desired length. Next, user inserts the insertion end 47 of the inner cylinder 22 within the locking apparatus's 40 slot 52, and rotates the locking tool 41 in a clockwise direction, thereby positionably locking the inner cylinder 22 against the locking tool 41 within the outer cylinder 26. At this point, a socket 60 is placed on the socket engaging end 29 of the inner cylinder 22 for engagement with a fastener to be tightened utilizing the telescopic ratchet extension 10.

In the event user desires to adjust a linear length of the extension member 20, user simply reinserts the insertion end 47 of the inner cylinder 22 within the slot 52 of the locking apparatus 40, and turns the locking tool 41 in a counter-clockwise direction, thereby removing mechanical interference between the locking apparatus 40 and the inner cylinder 22, so as to allow the inner cylinder 22 to freely telescope within the outer cylinder 26.

The use of the present invention allows for convenient linear adjustments without utilizing different length extensions.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be broadly limited only by the following Claims.

What is claimed is:

1. A ratchet extension comprising:
an elongated, cylindrical extension member, said elongated, cylindrical extension member is telescopic and fabricated of tool steel metal material being chrome plated so as to retard rust; and
a locking apparatus, said locking apparatus includes a locking tool.

2. The ratchet extension of claim 1, wherein said elongated, cylindrical extension member includes an inner cylinder telescopically received by an outer cylinder, said outer cylinder is of a linearly, elongated configuration, having an anterior end opposite a posterior end, and wherein said outer cylinder is further defined as having a circular cross-section and an inner cylinder receiving cavity for intimate slidable engagement by said inner cylinder.

3. The ratchet extension of claim 2, wherein said anterior end of said outer cylinder is defined as having a downwardly-tapering drive shaft terminating into a socket engaging end, and wherein said anterior end includes threads for mating with corresponding threads of said locking apparatus.

4. The ratchet extension of claim 2, wherein said posterior end of said outer cylinder defines a ratchet receiving cavity formed as a rectangular void adapted so as to be engaged by an extension engagement end of a standard ratchet wrench.

5. The ratchet extension of claim 2, wherein said inner cylinder is of a linearly elongated configuration having a circular cross-section and a diameter measuring just shy a diameter of said inner cylinder receiving cavity of said outer cylinder.

6. The ratchet extension of claim 3, wherein said locking apparatus has inner corresponding threads for threadedly engaging said threads of said anterior end of said outer cylinder, said locking apparatus includes a square-shaped slot extending through said locking apparatus for accommodating an insertion end of said inner cylinder, and wherein said locking apparatus allows for said inner cylinder to be locked at any position along said outer cylinder, thereby allowing for a complete range of linear adjustment.

7. The ratchet extension of claim 1, wherein said locking tool includes a knurled gripping element, said knurled gripping element has a slightly downwardly-tapered lower portion which is removably affixed via crimping to said inner cylinder.

8. The ratchet extension of claim 7, wherein said locking tool includes a contacting surface, whereby manual clockwise rotation of said locking tool actuates mechanical impingement by said contacting surface against an outer circumferential sidewall of said inner cylinder, thereby positionably locking said inner cylinder within said outer cylinder, and whereupon manual counter-clockwise rotation of said locking tool facilitates removal of mechanical interference between said contacting surface and said inner cylinder so as to allow said inner cylinder to freely telescope within said outer cylinder.

9. The ratchet extension of claim 5, wherein said inner cylinder has measuring indicia engraved along an external circumferential surface of said inner cylinder in a sequentially progressive manner so as to allow said elongated, cylindrical extension member to be linearly adjusted and locked at a preselected position.
